(19) United States
(12) Patent Application Publication
(10) Pub. No.: US 2024/0394607 A1
(43) Pub. Date: Nov. 28, 2024

(54) INFORMATION PROCESSING DEVICE AND INFORMATION PROCESSING METHOD FOR DETERMINING STATION THAT VISITOR IS PROMPTED TO USE

(71) Applicant: Toyota Jidosha Kabushiki Kaisha, Toyota-shi (JP)

(72) Inventors: Makoto AKAHANE, Yokohama-shi (JP); Yu Nagata, Tokyo (JP); Tomokazu Maya, Nagoya-shi (JP); Masaaki Tomiya, Urayasu-shi (JP); Yuko Mineta, Tokyo (JP); Kayo Tsumoto, Nisshin-shi (JP); Shinichi Niwa, Nagakute-shi (JP); Satoshi Komamine, Nagoya-shi (JP)

(73) Assignee: Toyota Jidosha Kabushiki Kaisha, Toyota-shi (JP)

(21) Appl. No.: 18/417,044

(22) Filed: Jan. 19, 2024

(30) Foreign Application Priority Data
May 23, 2023 (JP) 2023-084888

(51) Int. Cl. G06Q 10/02

(52) U.S. Cl. CPC G06Q 10/02

(57) ABSTRACT

The information processing device includes a control unit that predicts the number of users of each of the plurality of stations on the event date based on the identification information of the visitor and the person flow data of each of the plurality of stations in the vicinity of the event place, and determines a station that prompts the visitor to use based on the identification information and the predicted number of users.

### CROSS-REFERENCE TO RELATED APPLICATION

This application claims priority to Japanese Patent Application No. 2023-084888 filed on May 23, 2023, incorporated herein by reference in its entirety.

### BACKGROUND

### 1. Technical Field

The present disclosure relates to an information processing device and an information processing method.

### 2. Description of Related Art

Hitherto, a technology for providing a user with a congestion status of a station has been known. For example, Japanese Unexamined Patent Application Publication No. 2018-010454 (JP 2018-010454 A) discloses a technology for providing a railway user with congestion statuses of a train on a railway and a station.

### SUMMARY

When an event is held along the railway, however, passengers come to a station nearest to an event place on an event date. For this reason, it is not necessarily sufficient from the viewpoint of reducing congestion to simply provide visitors to the event place with the congestion status of the nearest station.

Therefore, there is room for improvement in the technology for providing the user with the congestion status of the station.

In view of such circumstances, an object of the present disclosure is to improve a technology for providing a user with congestion statuses of a train and a station.

An information processing device according to an embodiment of the present disclosure is an information processing device configured to determine a station that a visitor to an event place is to be prompted to use. The information processing device includes a control unit configured to predict the numbers of users of a plurality of stations around the event place on a date of an event based on identification information of the visitor and pieces of person flow data of the stations, and determine the station that the visitor is to be prompted to use based on the identification information and the predicted numbers of users.

An information processing method according to an embodiment of the present disclosure is an information processing method to be executed by an information processing device configured to determine a station that a visitor to an event place is to be prompted to use. The information processing method includes: predicting the numbers of users of a plurality of stations around the event place on a date of an event based on identification information of the visitor and pieces of person flow data of the stations; and determining the station that the visitor is to be prompted to use based on the identification information and the predicted numbers of users.

According to the embodiments of the present disclosure, the technology for providing the user with the congestion status of the station is improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a schematic configuration of an information processing system according to an embodiment of the present disclosure;

FIG. 2 is a flow chart illustrating an operation of the information processing device; and

FIG. 3 is a diagram illustrating a schematic configuration of a periphery of an event place.

### DETAILED DESCRIPTION OF EMBODIMENTS

### Outline of Embodiment

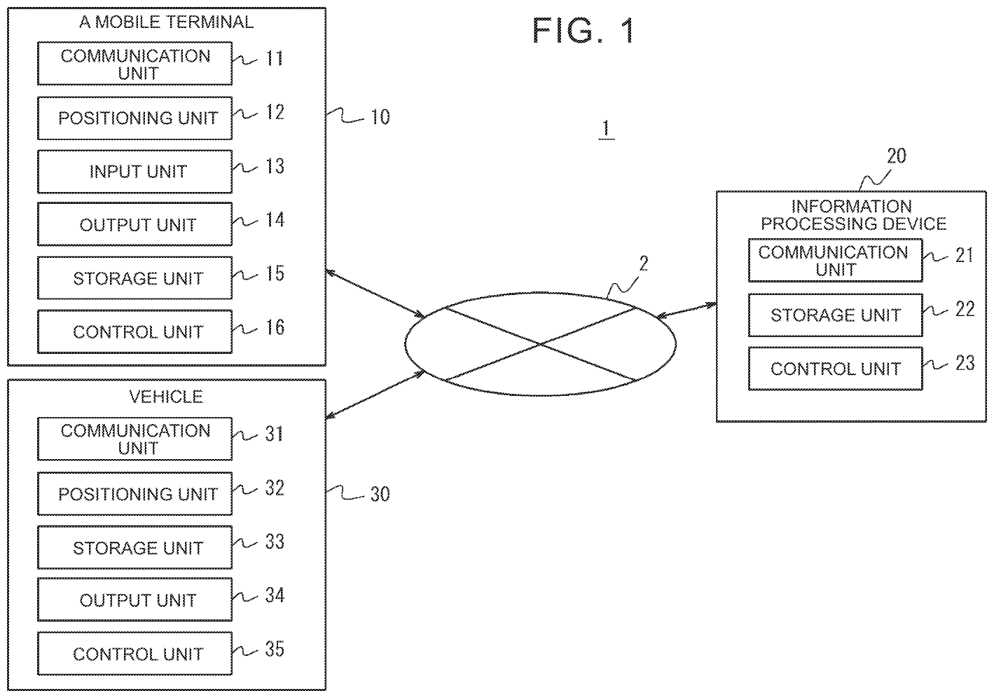

An outline of the information processing system 1 according to the embodiment of the present disclosure will be described with reference to FIG. 1. The information processing system 1 includes a mobile terminal 10, an information processing device 20, and a vehicle 30. The mobile terminal 10, the information processing device 20, and the vehicle 30 are communicably connected via the network 2.

The mobile terminal 10 is, for example, a mobile telephone, a smart phone, a tablet, or a personal computer Personal Computer (PC carried by a visitor. The mobile terminal 10 is communicably connected to the information processing device 20 and the vehicle 30 via the network 2.

The information processing device 20 is, for example, a computer such as a server apparatus. The information processing device 20 is communicably connected to the mobile terminal 10 and the vehicle 30 via the network 2.

The vehicle 30 is, for example, an automobile, but is not limited thereto, and may be any vehicle. Vehicles include, but are not limited to, gasoline-powered vehicles, Battery Electric Vehicle (BEV), Hybrid Electric Vehicle), Plug-in Hybrid Electric Vehicle (PHEV), or Fuel Cell Electric Vehicle (FCEV). The number of vehicles 30 included in the information processing system 1 may be arbitrarily determined.

The vehicle 30 is a pick-up vehicle that picks up visitors between a station and an event place. The vehicle 30 is communicably connected to the mobile terminal 10 and the information processing device 20 via the network 2.

First, the outline of the present embodiment will be described, and the details will be described later. The information processing device 20 predicts the number of users of each of the plurality of stations on the event date on the basis of the identification information of the visitor and the person flow data of each of the plurality of stations in the vicinity of the event place, and determines a station that prompts the visitor to use on the basis of the identification information and the predicted number of users.

As described above, according to the present embodiment, the information processing device 20 determines a station that prompts the visitor to use from among the plurality of stations based on the identification information of the visitor and the person flow data of each of the plurality of stations in the vicinity of the event place. Therefore, for example, even in a case where the concentration of visitors to the nearest station of the event place is expected, it is possible to urge the visitors to use the stations other than the nearest station. Therefore, the technology of providing the congestion situation of the train and the station to the user is improved in that the probability of reducing the congestion in the nearest station of the event place is improved.

Next, each configuration of the information processing system 1 will be described in detail.

### Configuration of Portable Terminal

As illustrated in FIG. 1, the mobile terminal 10 includes a communication unit 11, a positioning unit 12, an input unit 13, an output unit 14, a storage unit 15, and a control unit 16.

The communication unit 11 includes one or more communication interfaces connected to the network 2. The communication interfaces correspond to, but are not limited to, a mobile communication standard such as 4th Generation (4G) or 5th Generation (5G), a wired Local Area Network (LAN) standard, or a radio LAN standard. In the present embodiment, the mobile terminal 10 communicates with the information processing device 20 and the vehicle 30 via the communication unit 11 and the network 2.

The positioning unit 12 includes one or more devices that acquire position information of the mobile terminal 10. Specifically, the positioning unit 12 includes, for example, a receiver corresponding to GPS, but is not limited thereto, and may include a receiver corresponding to any satellite-based positioning system.

The input unit 13 includes at least one input interface capable of accepting input by a user. The input interface is, for example, a physical key, a capacitive key, a pointing device, a touch screen integrally provided with a display, a microphone, or the like. However, the input interface is not limited thereto.

The output unit 14 can output data. The output unit 14 is configured to include at least one output interface capable of output data. The output interface is, for example, a display or a speaker. The display is, for example, a LCD or an organic EL display. However, the output interface is not limited thereto.

The storage unit 15 includes one or more memories. The memory is, for example, a semiconductor memory, a magnetic memory, an optical memory, or the like, but is not limited thereto. Each memory included in the storage unit 15 may function as, for example, a main storage device, an auxiliary storage device, or a cache memory. The storage unit 15 stores arbitrary information used for the operation of the mobile terminal 10. For example, the storage unit 15 may store a system program, an application program, embedded software, booth reservation information in an event place, and reservation information of a pick-up vehicle. The information stored in the storage unit 15 may be updatable by, for example, information acquired from the network 2 via the communication unit 11.

The control unit 16 includes one or more processors, one or more programmable circuits, one or more dedicated circuits, or a combination of these. The processor may be, but is not limited to, a general-purpose processor such as, for example, Central Processing Unit (CPU) or Graphics Processing Unit (GPU), or a special-purpose processor specialized for a particular process. The programmable circuitry is, for example, but not limited to, Field-Programmable Gate Array (FPGA). The dedicated circuitry is, for example, but not limited to, Application Specific Integrated Circuit (ASIC). The control unit 16 controls the overall operation of the mobile terminal 10.

### Configuration of Information Processing Device

As illustrated in FIG. 1, the information processing device 20 includes a communication unit 21, a storage unit 22, and a control unit 23.

The communication unit 21 includes one or more communication interfaces connected to the network 2. The communication interface conforms to, for example, a mobile communication standard, a wired LAN standard, or a wireless LAN standard. However, the standards are not limited to these, and the communication interface may conform to any communication standard. In the present embodiment, the information processing device 20 communicates with the mobile terminal 10 and the vehicle 30 via the communication unit 21 and the network 2.

The storage unit 22 includes one or more memories. Each memory included in the storage unit 22 may function as, for example, a main storage device, an auxiliary storage device, or a cache memory. The storage unit 22 stores any information used for the operation of the information processing device 20. For example, the storage unit 22 may store a system program, an application program, a database, identification information of a visitor, human flow data of a plurality of stations around an event place, and the like. The information stored in the storage unit 22 may be updatable by, for example, information acquired from the network 2 via the communication unit 21.

The control unit 23 includes one or more processors, one or more programmable circuits, one or more dedicated circuits, or a combination of these. The control unit 23 controls the operation of the information processing device 20 as a whole. Configuration of Vehicle

As illustrated in FIG. 1, the vehicle 30 includes a communication unit 31, a positioning unit 32, a storage unit 33, an output unit 34, and a control unit 35.

The communication unit 31 includes one or more communication interfaces connected to the network 2. The communication interfaces correspond to, but are not limited to, mobile communication standards such as 4G or 5G, or in-vehicle networking (e.g., Controller Area Network (CAN)). In the present embodiment, the vehicle 30 communicates with the mobile terminal 10 and the information processing device 20 via the communication unit 31 and the network 2.

The positioning unit 32 includes one or more devices for acquiring the position information of the vehicle 30. Specifically, the positioning unit 32 includes, for example, a receiver corresponding to GPS, but is not limited to this, and may include a receiver corresponding to any satellite positioning system.

The storage unit 33 includes one or more memories. The memories are, for example, a semiconductor memory, a magnetic memory, or an optical memory, but are not limited to these memories. Each memory included in the storage unit 33 may function as a main storage device, an auxiliary storage device, or a cache memory, for example. The storage unit 33 stores arbitrary information used for the operation of the vehicle 30. For example, the storage unit 33 may store a system program, an application program, embedded software, identification information of a visitor, reservation information of a pick-up vehicle, and the like. The information stored in the storage unit 33 may be updatable by, for example, information acquired from the network 2 via the communication unit 31.

The output unit 34 is configured to include at least one audio output interface capable of outputting audio and at least one display interface capable of displaying text or video. The audio output interface is, for example, a speaker. The display interfaces are, for example, displays such as LCD or organic EL displays. The output unit 34 may display content associated with the event within the vehicle 30 via a speaker and/or a display. The audio output interface and the display interface are not limited thereto.

The control unit 35 includes one or more processors, one or more programmable circuits, one or more dedicated circuits, or a combination of these. The control unit 35 controls the operation of the entire vehicle 30.

### Operation Flow of Information Processing Device

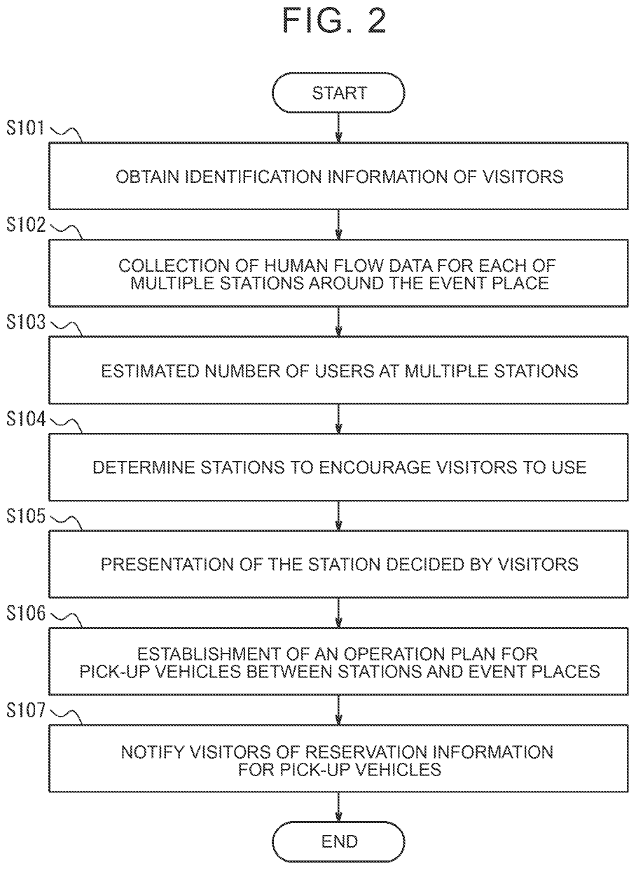

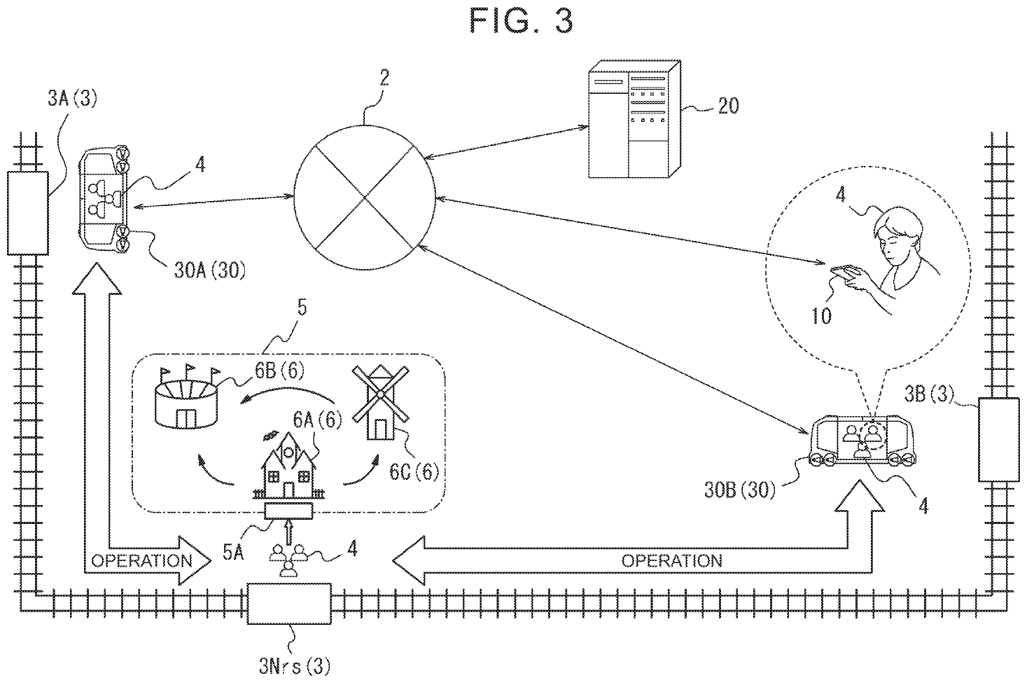

With reference to FIGS. 2 and 3, an operation of the information processing device 20 according to the present embodiment will be described. This operation relates to determining a station 3 that prompts the visitor 4 of the event place 5 to use.

In FIG. 3, the stations 3A, 3B, 3Nrs are a plurality of stations around the event place 5. For example, in the present disclosure, it is assumed that the station 3Nrs is the nearest station of the event place 5, and the stations 3A, 3B are the front and rear stations of the nearest station 3Nrs. The vehicles 30A and 30B are the pick-up vehicles 30 that carry the visitor 4 and travel back and forth between the stations 3A and 3B and the entrance 5A of the event place 5, respectively. The visitor 4 enters the event place 5 from the entrance 5A, and circulates one or more booths 6 (6A, 6B, 6C) installed in the event place 5, for example, on foot or in an autonomous vehicle (for example, an electric cart or a micro bus having a GPS function). In FIG. 3, the visitor 4 enters the entrance 5A on foot from the nearest station 3Nrs, but may be picked up by the pick-up vehicles 30.

S101: The control unit 23 acquires the identity of the visitor 4.

The control unit 23 acquires, via the network 2, the identification information transmitted from the mobile terminal 10 of the visitor 4 who visits the event at the time of purchase of the entrance ticket. The identification information includes, but is not limited to, a name of the visitor 4, a registered address of the visitor 4, a contact address such as a telephone number and an e-mail address of the visitor 4, a boarding route from a boarding station to be used to a getting-off station (used station, the station 3A, 3B or 3Nrs in FIG. 3), a scheduled time to arrive at a station to be used, a scheduled time to enter the event place 5, or a booth 6A to be first visited when entering the event place 5. The control unit 23 stores the acquired identification information of the visitor 4 in the storage unit 22. The storage unit 22 may store identification information (referred to as past identification information) of the visitor 4 who has visited the past event together with the identification information of the visitor 4 of the event to be predicted.

S102: The control unit 23 collects human flow data of each of a plurality of stations 3A, 3B, 3Nrs around the event place 5.

The human flow data indicates the number of people in a particular location (e.g., the number of users of stations moving inside the nearest station 3Nrs of the event place 5) and movement. By analyzing the number and movement of the users of the nearest station 3Nrs in a specific time period, the congestion state of the nearest station 3Nrs in the specific time period can be grasped. The control unit 23 collects, from external servers and the like, the human flow data of the event date of each of the plurality of stations 3A, 3B, 3Nrs in the vicinity of the event place 5, and stores the collected data in the storage unit 22.

S103: The control unit 23 predicts the number of users of each of the plurality of stations 3A, 3B, 3Nrs on the event date based on the identification information of the visitor 4 and the person flow data of each of the plurality of stations 3A, 3B, 3Nrs around the event place 5.

The following describes how to calculate the number of users U₁, U₂, and U₃ in each of the stations 3A, 3B, 3Nrs on the event date D₁. The number of users U₁, U₂, and U₃ are the sum of the number of visitors using each of the stations 3A, 3B, 3Nrs and the number of non-visitors using each of the stations 3A, 3B, 3Nrs (the users of the stations who do not visit the event). The number of users V₁, V₂, and V₃ of each of the stations 3A, 3B, 3Nrs in the past event date D₂ are extracted from the past human flow data of each of the stations 3A, 3B, 3Nrs in the D₂. The number of visitors W₁, W₂, and W₃ using each of the stations 3A, 3B, 3Nrs in the D₂ are aggregated from the previous visitor identities. The number of visitors X₁, X₂, and X₃, which are scheduled to use each of the stations 3A, 3B, 3Nrs on the event date D₁ to be predicted, are aggregated from the visitor identity of the D₁. The control unit 23 may predict the number of users U₁, U₂, U₃ of the stations 3A, 3B, 3Nrs, respectively, on D₁ by multiplying the number of visitors X₁, X₂, X₃ that are scheduled to use the stations 3A, 3B, 3Nrs, respectively, on D₁ by respective numerical values obtained by dividing the number of users V₁, V₂, V₃ of the stations 3A, 3B, 3Nrs, respectively, on D₂ by the number of visitors W₁, W₂, W₃ of the stations 3A, 3B, 3Nrs, respectively, on D₂. Equation (1) below is an equation for calculating the number of users U₁ of the station 3A in the event date D₁. The number of users U₂ of the station 3B and the number of users U₃ of the station 3Nrs are also calculated in the same manner.

U₁=(V₁/W₁)×X₁ (1)

For example, it is predicted that the number of users U₁ on D₁ is 150, assuming that the number of the users V₁ of the station 3A on D₂ is 100, the number of visitors W₁ using the station 3A on D₂ is 50, and that the number of visitors X₁ using the station 3A on D₁ is 75.

Equation (1) forecasts for the number of users U₁ on the event date D₁, assuming that the ratio of the number of users V₁ of the past event date D₂ to the number of visitors W₁ is the same ratio on the event date D₁ to be forecasted. However, the way of predicting the number of users U₁ is not limited to this.

The control unit 23 may predict the number of users U₁, U₂, and U₃ of each of the plurality of stations 3A, 3B, 3Nrs on a particular day, for each time zone in which one day is divided into a plurality of time zones. Even if the scheduled time to arrive at the station to be used for the identification information of the visitor 4 is included, it is difficult to predict the time period in which the visitor 4 returns from the event place 5 to the station. For this reason, when the time when the visitor 4 returns to the station is concentrated in a specific time zone, the station is congested in that time zone. To alleviate such congestion, the control unit 23 may predict the time zone of using the station that the visitor 4 is scheduled to use, based on the good traffic access from each of the plurality of stations 3A, 3B, 3Nrs to the booth 6A that is installed in the event place 5 and the visitor 4 is scheduled to first visit, the time the booth 6 is open and closed, the time the event in the booth 6 is open and finished, or when the booth 6 is a reservation time, the booking time of the visitor 4.

S104: The control unit 23 determines a station to prompt the visitor 4 to use on the basis of the identification information and the predicted number of users.

The control unit 23 determines, among the plurality of stations 3A, 3B, 3Nrs, a station at which the number of users is predicted not to be the largest as a station to which the visitor 4 is urged to use. For example, when the control unit 23 predicts that the number of users in the specific time period of the event opening date of the nearest station 3Nrs is the largest among the three stations, it decides to prompt the visitor 4 scheduled to use the nearest station 3Nrs in the specific time period to use the station 3A or 3B. The control unit 23 may determine, based on the registered address included in the identification information of the visitor 4 or the position of the boarding station, to prompt the use of the station in front of the station 3Nrs of the station 3A or 3B.

S105: The control unit 23 presents the station 3 determined as a station that prompts the visitor 4 to use.

For example, when it is predicted that the number of users in the specific time zone of the event date of the nearest station 3Nrs is the largest among the three stations, the control unit 23 transmits, via the communication unit 21 and the network 2, a notification prompting the use of the station 3A or 3B to the mobile terminal 10 of the visitor 4 who is scheduled to use the nearest station 3Nrs in the specific time zone. When the number of users of the station 3 scheduled to be used by the visitor 4 is not the maximum of the three stations, the control unit 23 may not transmit the notification to the mobile terminal 10 of the visitor 4, or may notify that the number of users of the nearest station 3Nrs is the maximum of the three stations.

S106: The control unit 23 formulates an operation plan of the pick-up vehicle 30 that picks up the visitor 4 in a section between each of the plurality of stations 3A, 3B, 3Nrs and the event place 5.

The pick-up vehicle 30 may provide the content related to the event to the visitor 4 who is the passenger by an output unit 34 (display and/or speaker) provided in the vehicle cabin. When the nearest station 3Nrs and the event place are close to each other, the pick-up vehicles 30 may not be operated.

S107: The control unit 23 notifies the visitor 4 of the reservation data of the pick-up vehicles 30.

The visitor 4 rides on the pick-up vehicle 30 that matches his/her reservation information. A plurality of pick-up vehicles 30 may be operated in a section between each of the stations 3A and 3B and the event place 5. When the visitor 4 returning from the event place 5 is transported to or from the station 3A or 3B by a plurality of pick-up vehicles 30, even if the pick-up vehicles 30 arrive at the station 3A or 3B at the same time, it is desirable to shift the timing or the position at which the visitor 4 gets off for each pick-up vehicle 30. By such a countermeasure, it is possible to alleviate the congestion of the station 3A or 3B. When the visitor 4 is made to wait in the vehicle cabin, the pick-up vehicle 30 may provide the visitor 4 with the content related to the event through the output unit 34 (display and/or speaker) provided in the vehicle cabin during the waiting time.

As described above, the information processing device 20 according to the present embodiment predicts the number of users of each of the plurality of stations 3A, 3B, 3Nrs on the event date based on the identification information of the visitor 4 and the person flow data of each of the plurality of stations 3A, 3B, 3Nrs around the event place 5, and determines the station 3 that prompts the visitor 4 to use based on the identification information and the predicted number of users.

According to this configuration, the information processing device 20 determines the station 3 that prompts the visitor 4 to use from among the plurality of stations 3A, 3B, 3Nrs based on the identification information of the visitor 4 and the person flow data of each of the plurality of stations 3A, 3B, 3Nrs around the event place 5. Therefore, for example, even when the concentration of the visitor 4 in the nearest station 3Nrs of the event place 5 is expected, the visitor 4 can be urged to use the station other than the nearest station 3Nrs. Therefore, the technique of providing the congestion state of the station to the user is improved in that the probability of reducing the congestion in the nearest station 3Nrs of the event place 5 is improved.

Although the present disclosure has been described above based on the drawings and the embodiments, it should be noted that those skilled in the art may make various modifications and alterations thereto based on the present disclosure. It should be noted, therefore, that these modifications and alterations are within the scope of the present disclosure. For example, the functions included in the configurations, steps, etc. can be rearranged so as not to be logically inconsistent, and a plurality of configurations, steps, etc. can be combined into one or divided.

For example, in the above-described embodiment, the configuration and operation of the information processing device 20 may be distributed among a plurality of computers capable of communicating with each other.

Further, an embodiment is also possible in which, for example, a general-purpose computer functions as the information processing device 20 according to the above embodiment. Specifically, a program describing processing contents for realizing each function of the information processing device 20 according to the above embodiment is stored in the memory of the general-purpose computer, and the program is read out and executed by the processor. Therefore, the present disclosure can also be realized as a program that can be executed by the processor or a non-transitory computer-readable medium that stores the program.

1. An information processing device comprising:
one or more processors; and
one or more memories storing instructions that are executable by the one or more processors and cause the one or more processors to
receive identification information of a visitor transmitted from a mobile terminal of the visitor when the visitor purchased a ticket to an event,
receive sets of person flow data regarding stations around an event location from an external server, the sets of person flow data indicating the number of people and a movement of the people around the respective stations,
predict crowd size at each of the stations on a date of the event, based on the identification information received from each visitor of the event and the sets of person flow data,
select a specific station among the stations based on the identification information and the predicted crowd size to which the visitors will be directed, the specific station being a station other than the station that is nearest to the event location, and
transmit reservation information to the mobile terminal, the reservation information being for a pick-up vehicle from the event location to the specific station and including a message indicating that the predicted crowd size at the nearest station to the event location is the largest among the stations,
wherein the instructions further cause the one or more processors to predict a time frame during which visitors of the event are likely to use a station from among the stations based on
i) traffic accessibility between each of the stations and a booth to be visited first by the visitors in the event location,
ii) an opening time and a closing time of the booth,
iii) a start time and an end time of an exhibit at the booth, or
iv) a reservation time of each of the visitors in a case where the booth is served by reservation.

2. The information processing device according to claim 1, wherein the predicted crowd size at the specific station is not the largest among the stations.

3. (canceled)

4. An information processing device comprising:
one or more processors; and
one or more memories storing instructions that are executable by the one or more processors and cause the one or more processors to
receive identification information of a visitor transmitted from a mobile terminal of the visitor when the visitor purchased a ticket to an event,
receive sets of person flow data regarding stations around an event location from an external server. the sets of person flow data indicating the number of people and a movement of the people around the respective stations,
obtain a ratio that is a numerical value derived by dividing a past crowd size at a given station of the stations by the number of visitors of a past event at the given station on a date of the past event, the past crowd size being represented by the number of people and being extracted from the person flow data,
predict a crowd size at each of the stations on a date of the event by multiplying an expected number of visitors of the event at each of the stations by the ratio,
select a specific station among the stations based on the identification information and the predicted crowd size to which the visitors will be directed, the specific station being a station other than the station that is nearest to the event location, and
transmit reservation information to the mobile terminal, the reservation information being for a pick-up vehicle from the event location to the specific station and including a message indicating that the predicted crowd size at the nearest station to the event location is the largest among the stations.

5. An information processing method to be executed by an information processing device, the information processing method comprising:
receiving identification information of a visitor transmitted from a mobile terminal of the visitor when the visitor purchased a ticket to an event;
receiving sets of person flow data regarding stations around an event location from an external server, the sets of person flow data indicating the number of people and a movement of the people around the respective stations;
predicting a crowd size at each of the stations on a date of the event, based on the identification information received from each visitor and the sets of person flow data;
selecting a specific station among the stations based on the identification information and the predicted crowd size to which the visitors will be directed, the specific station being a station other than the station that is nearest to the event location; and
transmitting reservation information to the mobile terminal, the reservation information being for a pick-up vehicle from the event location to the specific station and including a message indicating that the crowd size at the nearest station to the event location is the largest among the stations.
wherein the information processing method further includes predicting a time frame during which visitors of the event are likely to use a station from among the stations based on
i) traffic accessibility between each of the stations and a booth to be visited first by the visitors in the event location.
ii) an opening time and a closing time of the booth.
iii) a start time and an end time of an exhibit at the booth, or
iv) a reservation time of each of the visitors in a case where the booth is served by reservation.
